(19) United States
(12) Patent Application Publication
(10) Pub. No.: US 2023/0094416 A1
(43) Pub. Date: Mar. 30, 2023

(54) AGRICULTURAL PROTECTION STRUCTURE

(71) Applicant: Francisco Carlstein, Colorado Springs, CO (US)

(72) Inventor: Francisco Carlstein, Colorado Springs, CO (US)

(73) Assignee: Canna Construction Co LLP

(21) Appl. No.: 17/507,305

(22) Filed: Oct. 21, 2021

Related U.S. Application Data
(60) Provisional application No. 63/249,504, filed on Sep. 28, 2021.

(51) Int. Cl. A01G 13/02; E04B 1/24

(52) U.S. Cl. CPC A01G 13/0206; E04B 1/2403

(57) ABSTRACT

A modular agricultural protection structure may be constructed from vertical poles anchored in the ground, and beams and cross-beams welded to the top of the poles to form a top surface of the module. Load support structures may be welded to the beams, cross-beams, and poles, at regular intervals. Cables may be attached to the load bearing structures and used to support netting. A cable and pulley system may be included to retract the netting from over the top surface during climate weather in order for the plants to receive more sunlight. High quality/high strength materials and welding techniques may be used to provide protection even against several feet of snow accumulation without significant sagging of the netting. Clips may be attached between the cables and the netting at different locations on the top surface of the structure to further decrease sagging of the netting.

### CROSS-REFERENCE TO RELATED APPLICATION

This application claims priority to U.S. Provisional Patent Application No. 63/249,504, entitled “AGRICULTURAL PROTECTION STRUCTURE”, filed Sep. 28, 2021, the entire contents of which are incorporated by reference.

### BACKGROUND

Certain agricultural crops, such as cannabis, grow well at higher altitudes. These may include mountainous areas. However, these areas may experience extreme weather conditions during certain times of the year, such as strong winds, hail, and heavy snow. They may also be home to insects and animals that may damage crops. Accordingly, such crop may need protection from expected and unexpected extreme weather conditions throughout the growing season.

Conventional agricultural protection structures may include posts, beams, and crossbeams to form a supporting structure for netting. However, in extreme conditions, for examples, several feet of snow accumulation, the netting may sag and damage the crops and/or cause the structure itself may fail.

### SUMMARY

A module for use in an agricultural protection structure may be constructed from vertical poles anchored in the ground, and beams and cross-beams welded to the top of the poles to form a top surface of the module. Load support structures may be welded to the beams, cross-beams, and poles, e.g., using deep welding techniques, at regular intervals, e.g., every two to four feet. Cables may be attached to the load bearing structures and used to support netting.

A cable and pulley system may be included to retract the netting from over the top surface during climate weather in order for the plants to receive more sunlight.

High quality/high strength materials and welding techniques may be used to provide protection even against several feet of snow accumulation without significant sagging of the netting. For example, steel tubes of a steel typically used in oil mining rigs, such as carbon or special bar quality (SBR) steel, may be used for the vertical poles and/or beams and cross-beams. Galvanized stainless steel aircraft cable may also be used. The welds may be made using deep welding techniques.

Clips may be attached between the cables and the netting at different locations on the top surface of the structure to further decrease sagging of the netting. The clips may include a bottom portion with one or more locking members and a number of spine-shaped structures on base member. The bottom portion may be inserted into a top portion including slots to receive the locking members, apertures to accept the spine-shaped structures, and a cable aperture to connect the clip to a cable.

### BRIEF DESCRIPTION OF THE DRAWINGS

FIG. 1 is a top view of a module of an agricultural protection structure according to an embodiment.

FIG. 2 is a side view of a module of an agricultural protection structure according to an embodiment.

FIG. 3 is a perspective view of a module of an agricultural protection structure according to an embodiment.

FIG. 4 is a side view of a module of an agricultural protection structure including cables according to an embodiment.

FIG. 5 is a perspective view of a juncture between cross-beams of different modules of an agricultural protection structure and load bearing structures according to an embodiment.

FIGS. 6A and 6B are side views of anchoring systems for modules of an agricultural protection structure.

FIGS. 7A and 7B are side views of pulley tensioning systems for modules of an agricultural protection structure.

FIGS. 8A and 8b show welding structures between beams of for modules of an agricultural protection structure according to different embodiments.

FIGS. 9A and 9B show welding structures between beams of for modules of an agricultural protection structure according to another embodiment.

FIGS. 10A and 10B are perspective views of a clip assembly according to an embodiment.

### DETAILED DESCRIPTION

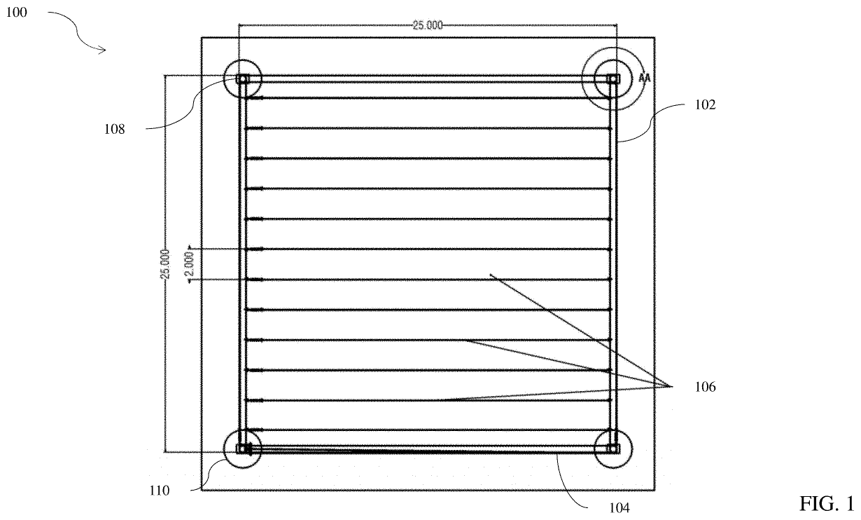

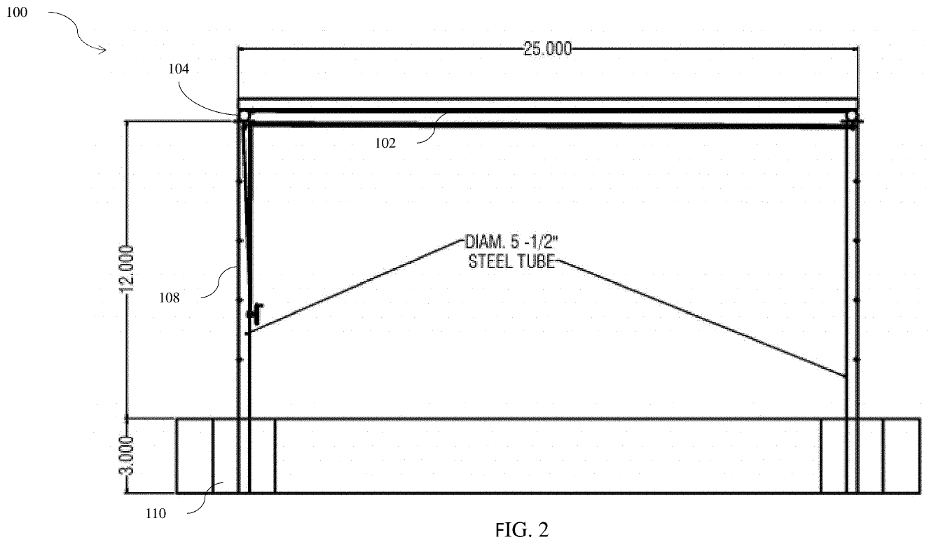

FIGS. 1 and 2 show a module 100 of an agricultural protection structure according to an embodiment. The agricultural protection structure may include a number of such modules in a grid format with intersecting beams 102 and crossbeams 104.

In an embodiment, the module may be between 25-30 feet on a side. High strength cables 106, for example, 3/16 inch wire rope, may be spaced approximately 2 feet apart across the top of the structure for stabilization purposes. The cables may be, for example, 1419 galvanized/stainless steel aircraft cable. In other embodiments, the distance between cables may be 3 to 4 feet. Vertical poles 108 positioned at the four corners of the module. 5½″ steel tubing may be used for the vertical poles 108, beams 102, and cross beams. The steel tubing may be recovered from oil drilling rigs, which are stronger and more durable than tubing usually employed for agricultural structures. These steels include, for example, carbon steel and engineered steel (or special bar quality (SBQ) steel). The vertical poles 108 may be anchored in concrete (anchoring structure 110). The anchoring structure 110 may be about 3 feet deep. Over time, the cables may be retensioned to account for stretching.

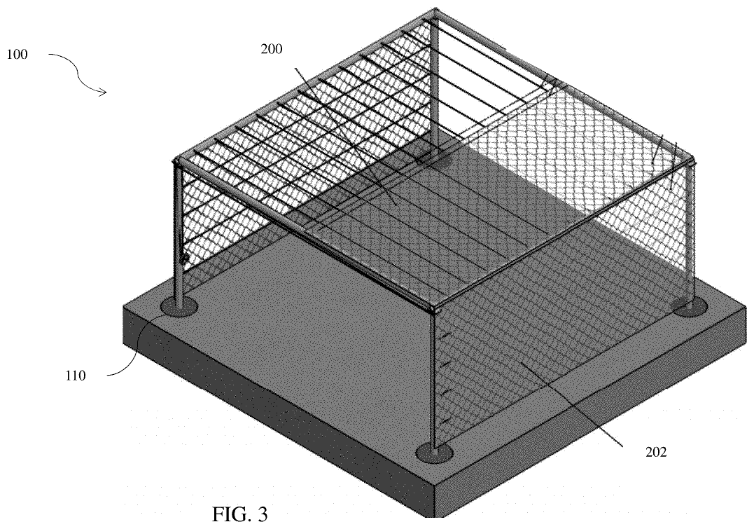

FIG. 3 is a perspective view of a module of an agricultural protection structure according to an embodiment. 20% shading mesh/netting 200 may be used on the top of the structure, and 40% shading mesh 202 may be used on the side of the structure. The netting may be heavy-duty mesh suitable for hail and snow protection and weighting due to accumulation.

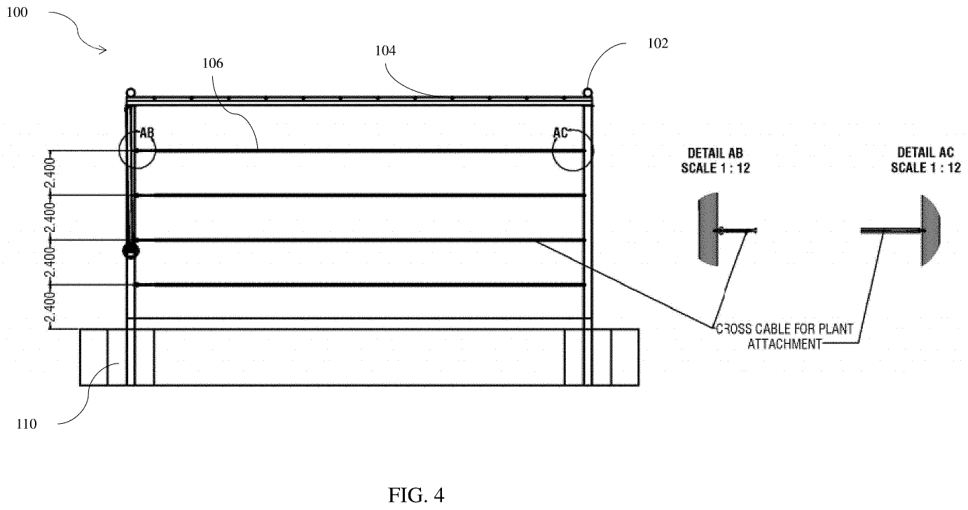

FIG. 4 is a side view of a module of an agricultural protection structure including cables. In an embodiment, the cables 106 on the sides of the structure may be spaced about 2.4 feet apart. In other embodiments, the cables may be spaced in a range of 2 to 4 feet apart.

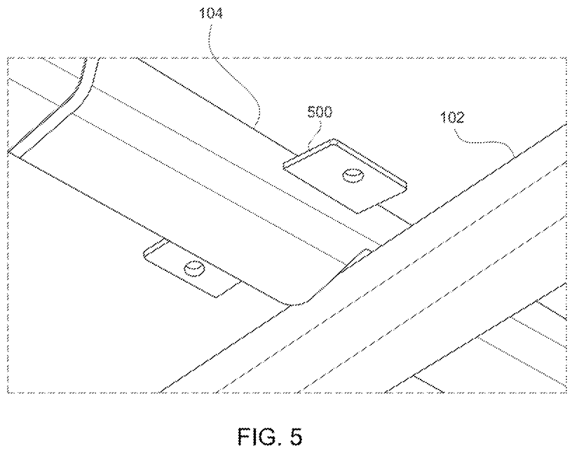

FIG. 5 shows a juncture between beams 102 and cross-beams 104 of different modules 100 of an agricultural protection structure and load bearing structures through which the cables may be extended. The junctures and load bearing structures may be welded using a deep weld technique. In an embodiment, a stainless 308L-16 1/16×10 arc welding stick electrode (SMAW) may be used, e.g., a Lincoln 7018 welding rod.

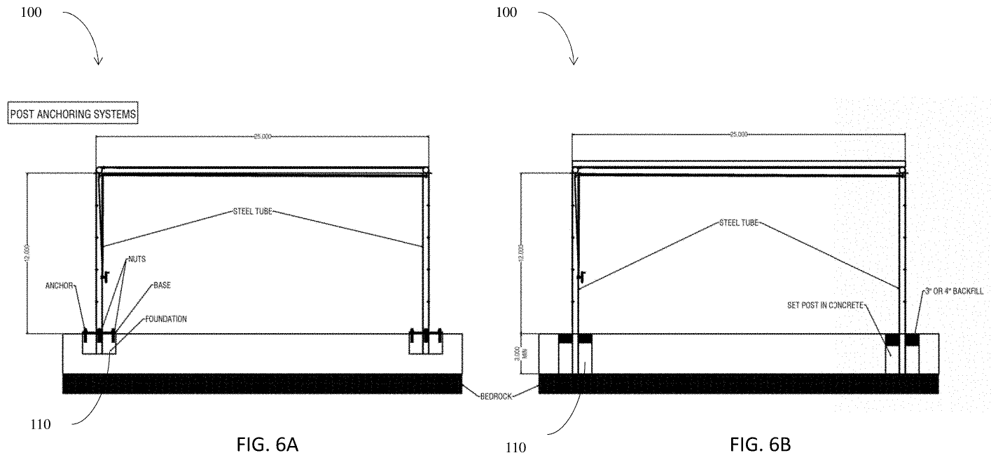

As shown in FIGS. 6A and 6B, the vertical poles may be set in concrete and/or plate welded.

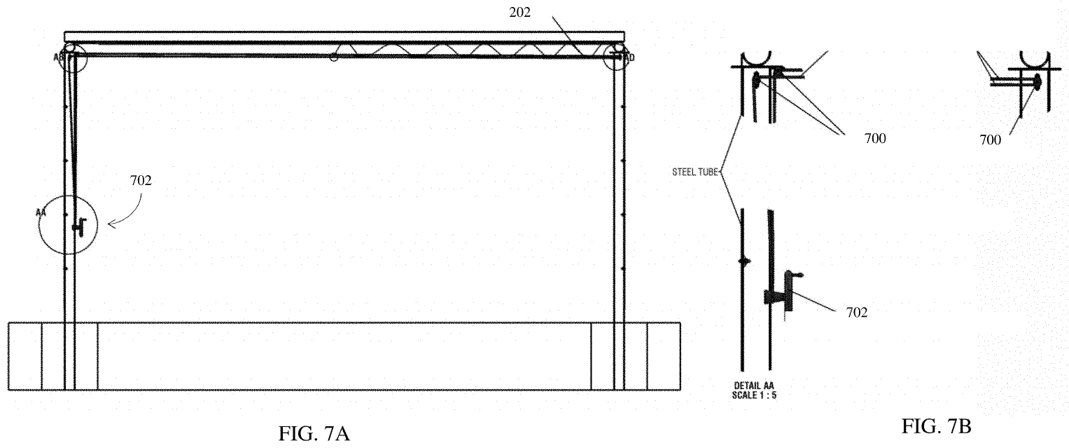

As shown in FIGS. 7A and 7B, a pulley tensioning system including pulleys 700 and cable(s) may be used to retract the netting if desired. The netting 200 may be retracting using the pulley system manually, e.g., using a dished wheel with stationary handle 702, or automatically using a motor. The motor may be programmed to retract and return the netting at designated times and/or be controlled remotely.

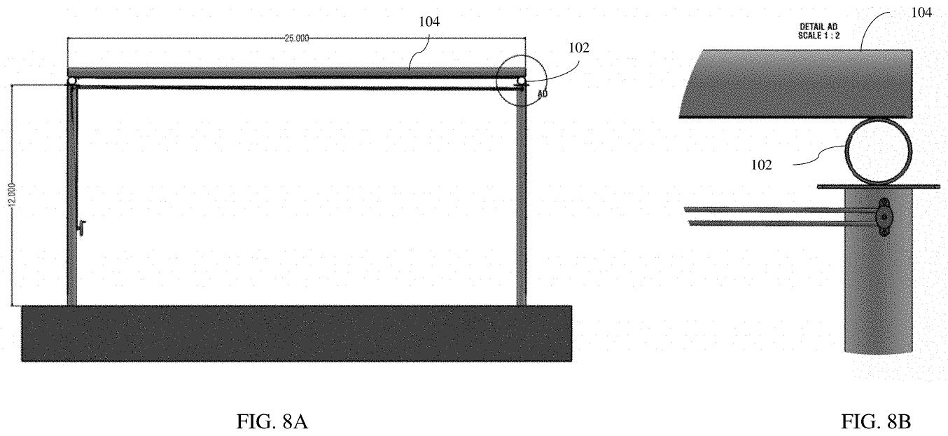

FIGS. 8A and 8B show welding structures between beams of modules of the agricultural protection structure according to an embodiment.

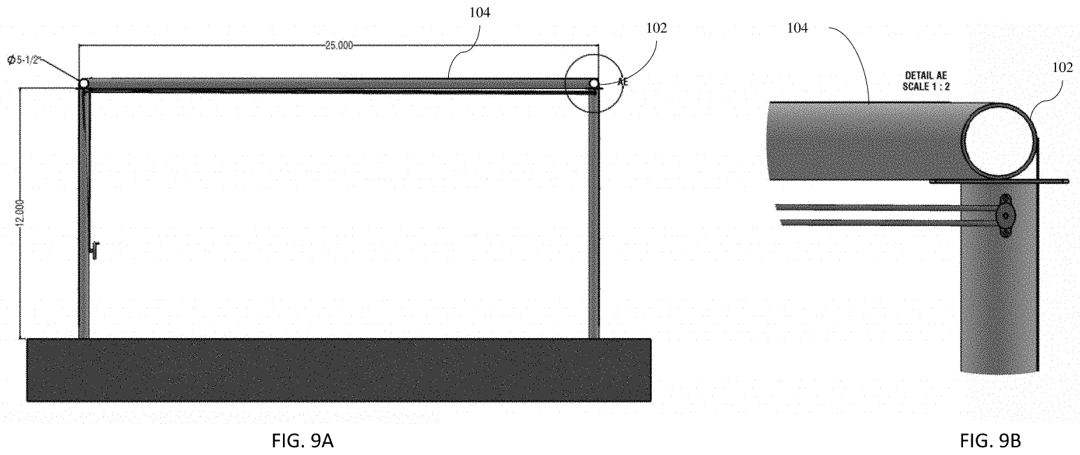

FIGS. 9A and 9B show welding structures between beams of modules of the agricultural protection structure according to another embodiment.

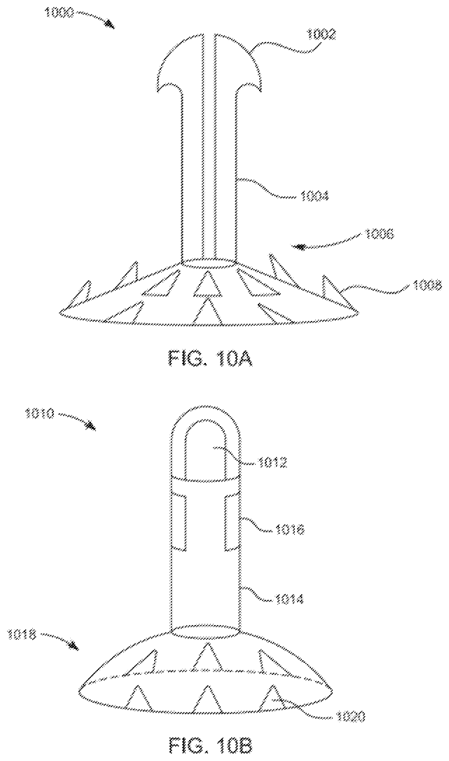

FIG. 10A shows a bottom portion 1000 of a net securing clip assembly according to an embodiment. In an embodiment, the bottom portion includes locking members 1002 on flexible legs 1004 which extend from a base 1006 including thorn or spine-shaped structures 1008 for penetrating the mesh at various locations. FIG. 10B shows a corresponding top portion 1010 of the clip assembly. The top portion 1010 includes an anchor for sliding on a cable, and a body 1014 including 1016 slots to accept the locking members 1002 in the bottom portion. A base 1018 includes apertures 1020 to accept corresponding spines 1008 in the bottom portion. The top portion of the clip may be positioned on a portion of a cable on the top surface of the module 100. The bottom portion may then be inserted through the netting 200 and slid into the body of the top portion until the locking members 1002 engage in the slots 1016. The spines 1008 may engage in the apertures 1020, sandwiching and securing the netting 200 and further preventing sagging of the net into the plants.

The combination of the materials and structures described ed above provide an extremely sturdy structure capable of handling large accumulations of snow. For example, one foot of snow accumulation over one square foot may weigh about fifteen pounds. In an embodiment, a module 100 may have a top surface area of about 625 ft². This may weigh over 9000 pounds over the entire structure, more than conventional agricultural structures could accommodate.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. An agricultural protection structure comprising:
a plurality of vertical poles;
a plurality of anchoring structures configured to anchor the vertical poles in the ground;
a plurality of beams welded to the vertical poles at a top portion of the vertical poles;
a plurality of cross-beams welded to the beams to form a top surface of the structure;
a plurality of load support structures welded at intervals along the beams or cross-beams;
a plurality of cables attached to the load support structures;
a netting covering the top surface of the structure and supported by the cables; and
a cable and pulley system to at least partially retract the netting from over the top surface.

2. The agricultural protection structure of claim 1, wherein the intervals comprise a range of between two and four feet.

3. The agricultural protection structure of claim 1, wherein the cables comprise galvanized stainless steel aircraft cable.

4. The agricultural protection structure of claim 1, wherein the beams and cross-beams comprises at least one of SBQ and carbon steel.

5. The agricultural protection structure of claim 1, wherein are constructed with deep welding techniques.

6. The agricultural protection structure of claim 1, further comprising a plurality of cables attached at intervals to the vertical poles to accommodate side netting.

7. The agricultural protection structure of claim 6, wherein the intervals on the vertical poles comprises a range of two to four feet.

8. The agricultural protection structure of claim 1, further comprising a plurality f clips attached between the cables and the netting at different locations on the top surface of the structure.

9. The agricultural protection structure of claim 8, wherein each of said plurality of clips comprise:
a bottom portion including
one or more locking members, and
a plurality of spines; and
a top portion including
a cable aperture,
one or more slots, each slot shaped to accept one of the locking members, and
a plurality of apertures, each aperture shaped to accommodate one of the spines.
